(19) United States
(12) Patent Application Publication
(10) Pub. No.: US 2007/0188386 A1
(43) Pub. Date: Aug. 16, 2007

(54) Solid flat antenna

(75) Inventor: Shih-Chieh Cheng, Tainan County (TW)

Correspondence Address: BIRCH STEWART KOLASCH & BIRCH, PO BOX 747, FALLS CHURCH, VA, 22040-0747, US

(73) Assignee: Arcadyan Tehnology Corporation

(21) Appl. No.: 11/407,197

(22) Filed: Apr. 20, 2006

(30) Foreign Application Priority Data
Feb. 10, 2006 (TW) 095104547

(51) Int. Cl. H01Q 1/38

(52) U.S. Cl. 343/700 MS; 343/893

(57) ABSTRACT

A solid flat antenna includes a reflecting unit, a first radiating unit and a second radiating unit. The reflecting unit has a first reflecting surface and a second reflecting surface. The first radiating unit, which has a first radiating portion and a first electrically connecting portion, is disposed opposite to the first reflecting surface, and one end of the first electrically connecting portion is electrically connected with the first radiating portion, which is disposed parallel to the first reflecting surface approximately. The second radiating unit, which has a second radiating portion and a second electrically connecting portion, is disposed opposite to the second reflecting surface, and one end of the second electrically connecting portion is electrically connected with the second radiating portion, which is disposed parallel to the second reflecting surface approximately. The other ends of the second electrically connecting portion and the first electrically connecting portion are electrically connected.

### BACKGROUND OF THE INVENTION

1. Field of Invention

The invention relates to an antenna and, in particular, to a solid flat antenna.

2. Related Art

The rapidly developed radio transmission has brought various products and technologies applied in the field of multi-band transmission, such that many new products have the performance of radio transmission to meet the consumer's requirement. The antenna is an important element for transmitting and receiving electromagnetic wave energy in the radio transmission system. If the antenna is lost, the radio transmission system cannot transmit and receive data. Thus, the antenna plays an indispensable role in the radio transmission system.

Selecting a proper antenna can match the feature of the product, enhance the transmission property, and further reduce the product cost. Different methods and different materials for manufacturing the antennas are used in different application products. In addition, considerations have to be taken when the antenna is designed according to different frequency bands used in different countries. The commonly used specifications of frequency band include IEEE 802.11, the most popular bluetooth communication (IEEE 802.15.1), and the like. IEEE 802.11 is further divided into 802.11a, 802.11b and 802.11 g, wherein the 802.11a specification corresponds to the frequency band of 5 GHz, and the 802.11b and 802.11 g specifications correspond to the frequency band of 2.4 GHz. The bluetooth works at the frequency band of 2.4 GHz.

The existing antennas can be roughly divided into omnidireactional and directional antennas. The omni-directional antenna has a wider angle in signal reception and emission. However, it is also likely to receive noise signals. The directional antenna has a higher gain and receives less noise signals than the omni-directional antennas. Nevertheless, its signal emission angle is narrower. The radiation field of either omni-directional antenna or directional antenna is fixed once the antenna design is done. The user is not able to change the radiation field of an antenna according to the environment.

Therefore, it is an important subject of the invention to provide a solid flat antenna that can change its radiation field according to needs while still having the advantages of high gain, lower power loss, and receiving less noise.

### SUMMARY OF THE INVENTION

In view of the foregoing, the invention is to provide a solid flat antenna with better communications quality.

To achieve the above, a solid flat antenna of the invention includes a reflecting unit, a first radiating unit and a second radiating unit. The reflecting unit has a first reflecting surface and a second reflecting surface. The first radiating unit, which has a first radiating portion and a first electrically connecting portion, is disposed opposite to the first reflecting surface. One end of the first electrically connecting portion is electrically connected with the first radiating portion, which is disposed approximately parallel to the first reflecting surface. The second radiating unit, which has a second radiating portion and a second electrically connecting portion, is disposed opposite to the second reflecting surface. One end of the second electrically connecting portion is electrically connected with the second radiating portion, which is disposed approximately parallel to the second reflecting surface. The other ends of the second electrically connecting portion and the first electrically connecting portion are electrically connected together.

As mentioned above, the solid flat antenna of the invention has a first radiating unit and a second radiating unit. The invention uses a reflecting unit to focus the emission power of the first and second radiating units toward a specific direction to increase the gain and reduce the power loss. Moreover, by selectively enabling individual or all the radiating units, the radiation field of the solid flat antenna can be changed. This makes the solid flat antenna suitable for different situations, increasing its competitive power.

### BRIEF DESCRIPTION OF THE DRAWINGS

The invention will become more fully understood from the detailed description given herein below illustration only, and thus is not limitative of the present invention, and wherein:

FIG. 1 is a three-dimensional view of a solid flat antenna according to a first embodiment of the invention;

FIG. 2 is another three-dimensional view of a solid flat antenna according to the first embodiment of the invention;

FIG. 3 is a three-dimensional view of a solid flat antenna according to a second embodiment of the invention;

FIG. 4 is another three-dimensional view of a solid flat antenna according to the second embodiment of the invention;

FIG. 5 is a top view of the solid flat antenna of FIG. 4; and

FIG. 6 is a schematic illustration showing a measured result of a radiation pattern on an E-Plane when the solid flat antenna of this embodiment is operating at 2.4 GHz.

### DETAILED DESCRIPTION OF THE INVENTION

The present invention will be apparent from the following detailed description, which proceeds with reference to the accompanying drawings, wherein the same references relate to the same elements.

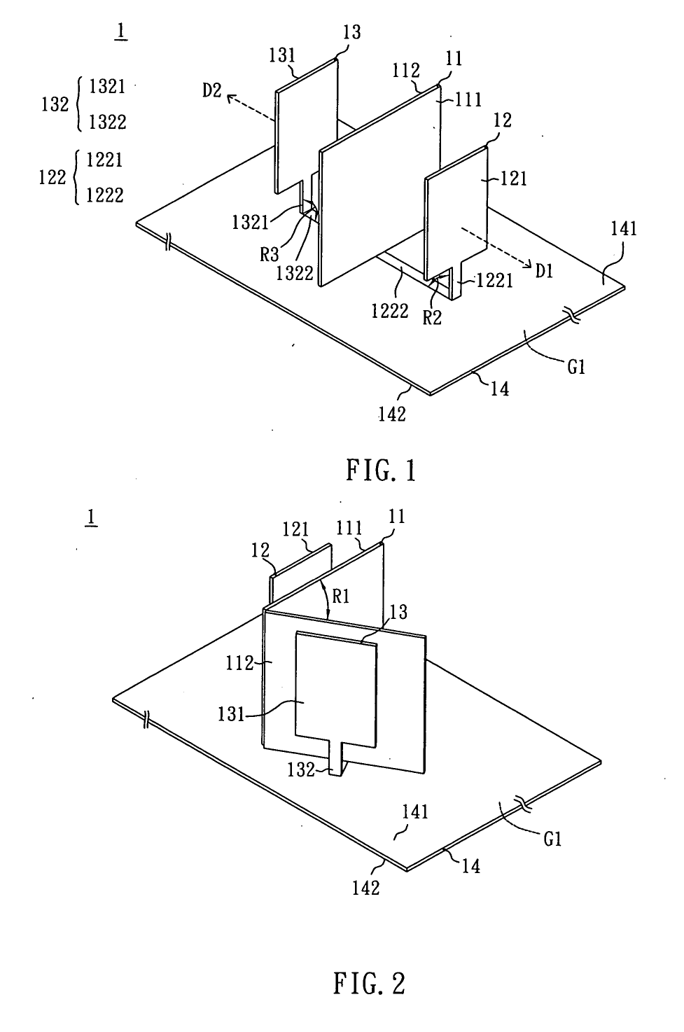

With reference to FIG. 1, the solid flat antenna 1 according to a first embodiment of the invention includes a reflecting unit 11, a first radiating unit 12, and a second radiating unit 13.

The reflecting unit 11 has a first reflecting surface 111 and a second reflecting surface 112. In this embodiment, the reflecting unit 11 has a sheet shape and is disposed opposite to the second reflecting surface 112. Besides, the first reflecting surface 111 and the second reflecting surface 112, which may be either curved or flat, are metal reflecting surfaces.

The first radiating unit 12, which has a first radiating portion 121 and a first electrically connecting unit 122, is disposed opposite to the first reflecting surface 111 of the reflecting unit 11. One end of the first electrically connecting portion 122 is electrically connected with the first radiating portion 121. The first radiating portion 121 is disposed approximately parallel to the first reflecting surface 111.

The second radiating unit 13, which has a second radiating portion 131 and a second electrically connection portion 132, is disposed opposite to the second reflecting surface 112 of the reflecting unit 11. One end of the second electrically connection portion 132 is electrically connected with the second radiating portion 131. The second radiating portion 132 is disposed approximately parallel to the second reflecting surface 112. Besides, the other ends of the second electrically connection portion 132 and the first electrically connection portion 122 are electrically coupled.

In this embodiment, the first radiating unit 12 focuses its emission power to a first direction D1 when it uses the first reflecting surface 111 to emit signals. The second radiating unit 13 uses the second reflecting surface 112 to focus its emission power toward a second direction D2. This increases the gain of the first radiating unit 12 and the second radiating unit 13 and reduces their power loss. Pointing power to a single direction is a feature of the directional antenna. Therefore, it receives less noise signals than the omni-directional antenna.

In addition to the sheet shape as described above, the reflecting unit 11 can be designed to have an angle R1 between the first reflecting surface 111 and the second reflecting surface 112, as shown in FIG. 2. Such modifications can be made in accordance with the products. Moreover, in this embodiment, the user can enable one or both of the first radiating unit 12 and the second radiating unit 13 to dynamically adjust the radiation field of the solid flat antenna 1.

It should be noted that the first radiating portion 121 and the second radiating portion 131 can be designed to have different shapes and embodiments in order for operations at different frequency bands, such as 2.4 GHz, 5 GHz, and other common bands. Of course, the first radiating portion 121 and the second radiating portion 131 can have a dual-band mode by employing an appropriate design.

With reference to FIG. 1 again, the solid flat antenna 1 further includes a substrate 14, which has a first surface 141 and a second surface 142 disposed opposite to the first surface 141. The second surface 142 is disposed with a ground conductor G1. The first radiating unit 12, the second radiating unit 13, and the reflecting unit 11 are disposed on the first surface 141. In this embodiment, one part 1221 of the first electrically connecting portion 122 and one part 1321 of the second electrically connecting portion 132 are disposed at angles R2 and R3 with respect to the first surface 141 of the substrate 14. The other part 1222 of the first electrically connecting portion 122 and the other part 1322 of the second electrically connecting portion 132 are disposed on the substrate 14. In this embodiment, the substrate 14 can be a printed circuit board (PCB) made of bismaleimide-triazine resin (BT resin) or fiberglass reinforced epoxy resin (FR4), a flexible film substrate made of polyimide, or even be integrated as part of a circuit board to save space.

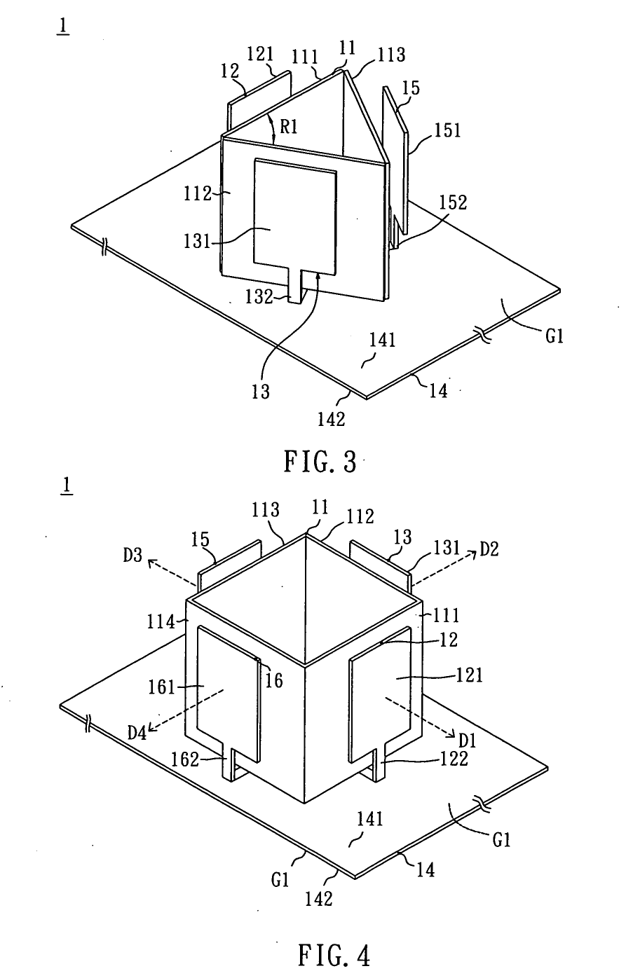

Please refer to FIG. 3. The differences from the previous embodiment are that the solid flat antenna 1 in this second embodiment of the invention further includes a third radiating unit 15, that its reflecting unit 11 is either hollow or in a pillar shape, and that it includes a third reflecting surface 113. The first, second, and third reflecting surfaces 111, 112, 113 form a triangular pillar. The third radiating unit 15 is disposed opposite to and approximately parallel to the third reflecting surface 113. It has a third radiating portion 151 and a third electrically connecting portion 152. One end of the third electrically connecting portion 152 is electrically connected with the third radiating portion 151. The other end of the third electrically connecting portion 152 is electrically connected with a feeding point. In this embodiment, one part of the third electrically connecting portion 152 is disposed at an angle with respect to the first surface 141 of the substrate 14. The other part of the third electrically connecting portion 152 is disposed on the first surface 141 of the substrate 14.

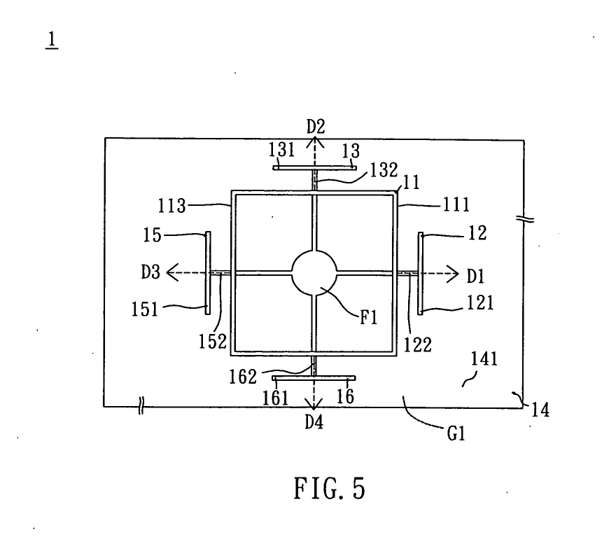

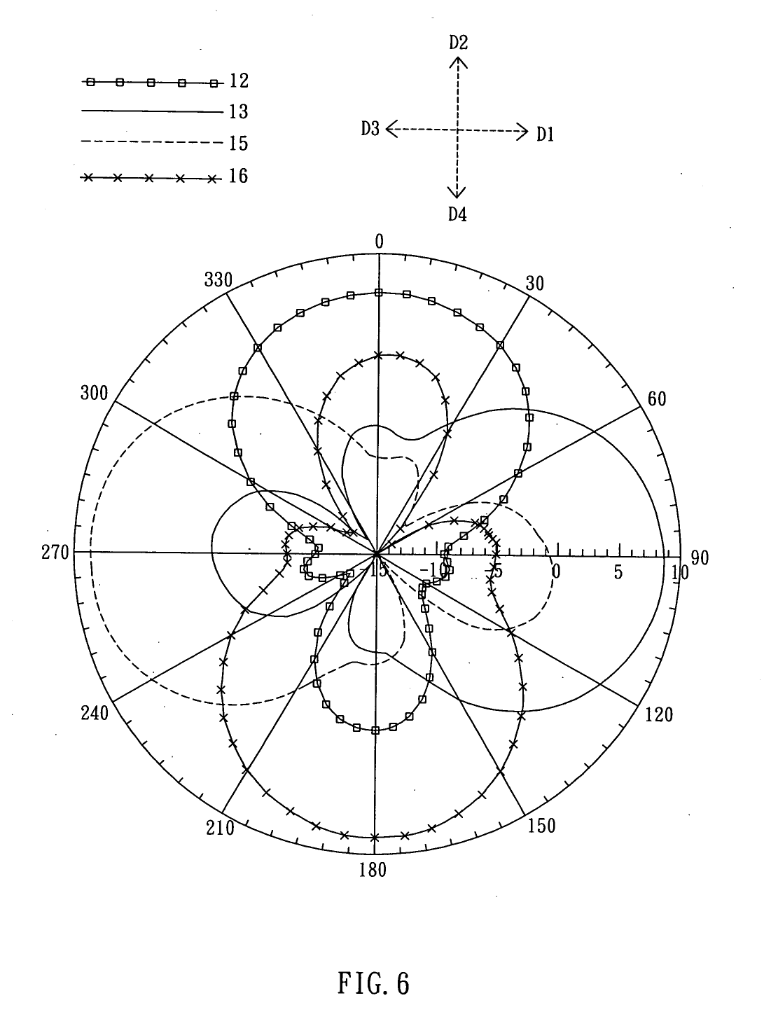

With simultaneous reference to FIGS. 4 and 5, the solid flat antenna 1 further includes a fourth radiating unit 16. The reflecting unit 11 also correspondingly includes a fourth reflecting surface 114. In this embodiment, the third reflecting surface 113 and the fourth reflecting surface 114 may be curved or flat metal reflecting surfaces, as in the case of the first and second reflecting surfaces 111 and 112. The first reflecting surface 111, the second reflecting surface 112, the third reflecting surface 113, and the fourth reflecting surface 114 form a polygonal pillar.

The fourth radiating unit 16 is disposed opposite to and approximately parallel to the fourth reflecting surface 114. It has a fourth radiating portion 161 and a fourth electrically connecting portion 162. One end of the fourth electrically connecting portion 162 is electrically connected with the fourth radiating portion 161. The other end of the fourth electrically connecting portion 162 is electrically connected with the feeding point F1 (FIG. 5). In this embodiment, one part of the fourth electrically connecting portion 162 is disposed at angle with respect to the first surface 141 of the substrate 14. The other part of the fourth electrically connecting portion 162 is disposed on the first surface 141 of the substrate 14. The third radiating unit 15 focuses its emission power in a third direction D3 when it uses the third reflecting surface 113 to emit signals. The fourth radiating unit 16 focuses its emission power in a fourth direction D4 when it uses the fourth reflecting surface 114 to emit signals. Therefore, the third radiating unit 15 and the fourth radiating unit 16 can be used to increase the angle of the emitted signals, covering the dead angle of the first radiating unit 12 and the second radiating unit 13 and changing the radiation field. Of course, the solid flat antenna 1 may be added with more radiating units and oppositely disposed reflecting surfaces in order to have more changes in the radiation field.

FIG. 6 shows the measured result of a radiation pattern on an E-plane obtained from the solid flat antenna 1 of FIGS. 4 and 5 operating at the frequency of 2.4 GHz. The measured result shows that the disclosed solid flat antenna 1 can focus its emission power in the first direction D1, the second direction D2, the third direction D3, and the fourth direction D4 when it emits signals from the first radiating unit 12, the second radiating unit 13, the third radiating unit 15, and the fourth radiating unit 16 via the first reflecting surface 111, the second reflecting surface 112, the third reflecting surface 113, and the fourth reflecting surface 114, respectively, thereby enhancing the gain. Besides, the first radiating unit 12, the second radiating unit 13, the third radiating unit 15, and the fourth radiating unit 16 can be selectively used to emit signals in such a way to prevent obstacles in the environment. In other words, the first radiating unit 12, the second radiating unit 13, the third radiating unit 15, and the fourth radiating unit 16 can be individually or simultaneously enabled to dynamically adjust the radiation field.

In summary, the disclosed solid flat antenna uses a reflecting unit to focus the emission power of a single radiating unit toward a specific direction to increase the gain and reduce the power loss. Therefore, it receives less noise than omnidireactional antennas. Moreover, by selectively enabling individual or all the radiating units, the radiation field of the solid flat antenna can be changed. If more radiating units and reflecting surfaces are provided, more possibilities the radiating field can be. This makes the solid flat antenna suitable for different situations, increasing its competitive power.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A solid flat antenna, comprising:
a reflecting unit, which has a first reflecting surface and a second reflecting surface;
a first radiating unit, which is disposed opposite to the first reflecting surface and has a first radiating portion and a first electrically connecting portion, the first radiating portion being disposed approximately parallel to the first reflecting surface and one end of the first electrically connecting portion being electrically connected with the first radiating portion; and
a second radiating unit, which is disposed opposite to the second reflecting surface and has a second radiating portion and a second electrically connecting portion, the second radiating portion being disposed approximately parallel to the second reflecting surface and one end of the second electrically connecting portion being electrically connected with the second radiating portion;
wherein the other ends of the first electrically connecting portion and the second electrically connecting portion are electrically connected.

2. The solid flat antenna of claim 1, wherein the other ends of the second electrically connecting portion and the first electrically connecting portion are electrically connected to a feeding point.

3. The solid flat antenna of claim 1, further comprising:
a substrate, which has a first surface and a second surface opposite to the first surface, wherein the first radiating unit, the second radiating unit, and the reflecting unit are disposed on the first surface.

4. The solid flat antenna of claim 3, wherein the substrate is a printed circuit board.

5. The solid flat antenna of claim 3, wherein one part of the first electrically connecting portion is disposed at an angle with respect to the first surface of the substrate.

6. The solid flat antenna of claim 3, wherein one part of the second electrically connecting portion is disposed at an angle with respect to the first surface of the substrate.

7. The solid flat antenna of claim 3, wherein the second surface of the substrate is disposed with a ground conductor.

8. The solid flat antenna of claim 1, wherein the reflecting unit is in a shape of a pillar.

9. The solid flat antenna of claim 1, wherein the reflecting unit is in a shape of a hollow pillar.

10. The solid flat antenna of claim 1, wherein the reflecting unit is in a shape of a triangular pillar.

11. The solid flat antenna of claim 1, wherein the reflecting unit is in a shape of a polygonal pillar.

12. The solid flat antenna of claim 1, wherein the first reflecting surface and the second reflecting surface of the reflecting unit are respectively metal reflecting surfaces.

13. The solid flat antenna of claim 1, wherein the first reflecting surface is disposed at an angle with respect to the second reflecting surface.

14. The solid flat antenna of claim 1, wherein the reflecting unit further has a third reflecting surface.

15. The solid flat antenna of claim 14, further comprising:
a third radiating unit, which is disposed opposite to the third reflecting surface and has a third radiating portion and a third electrically connecting portion, wherein the third radiating portion and the third reflecting surface are disposed approximately parallel to each other, one end of the third electrically connecting portion is electrically connected with the third radiating portion, and the other ends of the first electrically connecting portion, the second electrically connecting portion, and the third electrically connecting portion are electrically connected.

16. The solid flat antenna of claim 15, wherein the other ends of the third electrically connecting portion, the second electrically connecting portion and the first electrically connecting portion are electrically connected to a feeding point.

17. The solid flat antenna of claim 15, further comprising:
a substrate, which has a first surface and a second surface opposite to the first surface, wherein the first radiating unit, the second radiating unit, the third radiating unit, and the reflecting unit are disposed on the first surface.

18. The solid flat antenna of claim 17, wherein one part of the third electrically connecting portion is disposed at an angle with respect to the first surface of the substrate.

19. The solid flat antenna of claim 15, wherein the reflecting unit further has a fourth reflecting surface.

20. The solid flat antenna of claim 19, further comprising:
a fourth radiating unit, which is disposed opposite to the fourth reflecting surface and has a fourth radiating portion and a fourth electrically connecting portion, wherein the fourth radiating portion and the fourth reflecting surface are disposed approximately parallel to each other, one end of the fourth electrically connecting portion is electrically connected with the fourth radiating portion, and the other ends of the first electrically connecting portion, the second electrically connecting portion, the third electrically connecting portion, and the fourth electrically connecting portion are electrically connected.

21. The solid flat antenna of claim 20, wherein the other ends of the fourth electrically connecting portion, the third electrically connecting portion, the second electrically connecting portion and the first electrically connecting portion are electrically connected to a feeding point.

22. The solid flat antenna of claim 20, further comprising:
a substrate, which has a first surface and a second surface opposite to the first surface, wherein the first radiating unit, the second radiating unit, the third radiating unit, the fourth radiating unit, and the reflecting unit are disposed on the first surface.

23. The solid flat antenna of claim 22, wherein one part of the fourth electrically connecting portion is disposed at an angle with respect to the first surface of the substrate.

24. The solid flat antenna of claim 19, wherein the third reflecting surface or the fourth reflecting surface of the reflecting unit is a metal reflecting surface.

25. The solid flat antenna of claim 1, wherein the solid flat antenna operates in the band of about 2.4 GHz or 5 GHz.
